(19) United States
(12) Patent Application Publication
(10) Pub. No.: US 2022/0304309 A1
(43) Pub. Date: Sep. 29, 2022

(54) IRON COMPLEXES AND USES THEREFOR

(71) Applicant: Mark Vandeyar, Fairfax, VA (US)

(72) Inventor: Mark Vandeyar, Fairfax, VA (US)

(21) Appl. No.: 17/636,813

(22) PCT Filed: Aug. 18, 2020
(86) PCT No.: PCT/US2020/046753

§ 371 Date: Feb. 18, 2022

Related U.S. Application Data
(60) Provisional application No. 62/888,882, filed on Aug. 19, 2019.
(60) Provisional application No. 62/888,883, filed on Aug. 19, 2019.
(60) Provisional application No. 62/888,885, filed on Aug. 19, 2019.

(51) Int. Cl. A01N 59/16; A01P 1/00; C05F 11/00; A23L 19/00

(52) U.S. Cl. CPC A01N 59/16; A01P 1/00; C05F 11/00; A23L 19/00; A23V 2002/00

(57) ABSTRACT

Provided herein are complexes of ferrous (Fe²⁺) ion with pyruvate ion and with citrate ion, and methods of making such complexes. The ferrous complexes are useful, inter alia, for providing ferrous iron to plants in a stable form, e.g., for treatment of chlorosis and microbial infections, and for preparation of iron-fortified vegetables as foodstuffs. The ferrous complexes are also useful, inter alia, for providing ferrous iron to humans and other animals in a stable form, e.g., for treatment of iron deficiency, treatment of microbial infections and as topical antiseptics and sterilizing agents. Also provided are complexes of ferric (Fe³⁺) ion with pyruvate ion, and methods for making such complexes. The ferric complexes are useful, inter alia, for sustained release of ferrous iron to a subject such as a plant or animal.

### CROSS-REFERENCE TO RELATED APPLICATIONS

This application claims priority to U.S. Provisional Patent Application No. 62/888,882 filed Aug. 19, 2019; U.S. Provisional Patent Application No. 62/888,883 filed Aug. 19, 2019; and U.S. Provisional Patent Application No. 62/888,885 filed Aug. 19, 2019. For the purposes of the United States, this application claims the benefit, under 35 U.S.C. 119(e), of U.S. Provisional Patent Application No. 62/888,882 filed Aug. 19, 2019; U.S. Provisional Patent Application No. 62/888,883 filed Aug. 19, 2019; and U.S. Provisional Patent Application No. 62/888,885 filed Aug. 19, 2019; the disclosures of which are hereby incorporated herein by reference in their entireties, including text and figures.

### FIELD

The present disclosure is in the fields of plant pathology and microbiology. It provides treatments for certain disorders of plants, particularly, disorders associated with iron deficiency and microbial infections; and provides bacteriocidal, bacteriostatic, fungicidal and fungistatic compositions and methods.

### BACKGROUND

Chlorosis, a plant disease resulting from iron deficiency, results inter alia in yellowing of leaves and stems, due to lack of chlorophyll.

In plants, iron is present on two oxidation states: the reduced ferrous (Fe²⁺) ion and the oxidized ferric (Fe³⁺) ion. The ferrous (Fe²⁺) ion is the biologically active form of iron in plants.

In most soils, iron is abundant, but not biologically available to plants; because it exists in the ferric form as ferric oxide and ferric hydroxide. Accordingly, many plants require administration of exogenous iron. Typical treatments for iron deficiency include (1) soil application of soluble iron compounds (generally ferric iron), (2) application of an EDTA-ferric iron chelate, and (3) foliar application of soluble ferrous ion. All of these methods have drawbacks. Soil application of soluble iron is generally ineffective in alkaline soils (about 25-30% of soil is alkaline) due to the ability of the alkaline soil to render the applied iron insoluble and thus unavailable to the plant. EDTA-iron chelates are also ineffective in alkaline soils because the iron is readily converted to insoluble ferric oxides and ferric hydroxides. Foliarly-applied ferrous ion, being exposed to the atmosphere, is readily oxidized to the ferric form, which is not absorbed by the plant.

U.S. Pat. No. 8,945,631 describes aqueous solutions containing Fe²⁺ ion at a concentration of 10 mg/l (˜178 μM) to 100 mg/l total iron (˜1.78 mM), and an organic acid, for treatment of citrus greening disease. U.S. Pat. No. 8,945,631 teaches that the organic acid comprises at least one of a carboxyl group and a hydroxyl group, and that the total number of carboxyl groups and hydroxyl groups in the acid is two or more (i.e., the organic acid must have two or more carboxyl groups, or two or more hydroxyl groups, or at least one each of a carboxyl group and a hydroxyl group).

Kim et al. (1972) Analytical Letters 5:703-715 describe 1:1 complexes of Fe³⁺ and pyruvate ion and 2:1 complexes of Fe²⁺ and pyruvate. However, their measurements of complex formation were carried out in citrate, which itself complexes with both Fe²⁺ and Fe³⁺. See, for example, U.S. Pat. No. 2,904,573 (Sep. 15, 1959). Because of this, the stoichiometries they obtained for ferrous-pyruvate and ferric-pyruvate complexes are likely to be inaccurate.

Accordingly, there is a need for compositions comprising stable ferrous ion in a soluble form that is not susceptible to oxidation. In addition, such compositions must be small enough (i.e., of sufficiently low molecular weight) to be absorbed efficiently by plant cells.

In the therapeutic area, the incidence of microbial infections due to multidrug resistant pathogens is increasing worldwide. Bacterial pathogens with increasing incidences of drug resistance include multiple drug resistant Mycobacterium tuberculosis (MDR-TB), methicillin-resistant Staphylococcus aureus (MRSA), multidrug-resistant Streptococcus pneumoniae, vancomycin-resistant Enterococci (VRE), multidrug-resistant Acinetobacter baumannii, Pseudomonas aeruginosa and Enterobacteriaceae (including Klebsiella pneumoniae and Escherichia coli). A recently encountered drug-resistant fungus is Candida auris. Multiple drug resistance results in limited therapeutic options and impacts the ability to treat bacterial infections that afflict millions of people leading to suffering, economic loss and premature death

The emergence of multiple drug resistance to antibiotics is well documented for both Gram-negative bacteria and Gram-positive bacteria. Due to the presence of a second outer membrane, Gram-negative bacteria are more resistant to antibiotics than Gram-positive bacteria. This second outer membrane serves as an efficient barrier to both hydrophilic and hydrophobic compounds resulting in Gram-negative bacterial infections being typically more problematic to treat since there are fewer classes of antibiotics available for effective treatment.

Vilcheze et. al. teaches that Mycobacterium tuberculosis is extraordinarily sensitive to being killed by an ascorbic acid-induced Fenton reaction. The bactericidal activity of ascorbic acid against M. tuberculosis was dependent on the ability of ascorbic acid to reduce ferric iron to the ferrous oxidation state. This ferrous iron reacted with hydrogen peroxide resulting in the production of reactive oxygen species (ROS), which caused a pleiotropic effect affecting several biological processes, including damage to DNA and oxidation of other essential macromolecules.

These results suggest that ferrous (Fe²⁺) iron might be useful as a bacteriocidal or bacteriostatic agent. However, under physiological conditions, iron is normally present in the ferric (Fe³⁺) oxidation state, and ferrous iron introduced into a subject is rapidly oxidized to the ferric state. Ferric iron does not possess Fenton activity; i.e., it does not react with hydrogen peroxide to produce reactive oxygen species (ROS).

In view of the increasing rates of bacterial resistance to antibiotics, there is a need for novel therapeutic compositions with broad spectrum antimicrobial activity, that will reduce or eliminate the emergence of resistance, and that will reduce side effects as well as the costs of the treatments.

There is a further need for compositions comprising stable ferrous iron in a soluble form that is not susceptible to oxidation. In addition, such compositions must be small enough (i.e., of sufficiently low molecular weight) to be absorbed by the human or animal gut and to be passively absorbed by bacterial cells.

In the area of nutrition, iron is an essential trace element in animals (including humans) because, inter alia, it is an essential constituent of hemoglobin, myoglobin and many different iron-dependent enzymes. In addition to erythropoiesis, iron is essential for mitochondrial function, DNA synthesis and repair, and many enzymatic reactions required for cell survival. Iron deficiency (generally indicated as anemia) may contribute to cognitive developmental defects, poor physical performance, and unfavorable pregnancy outcomes.

The absorption of iron, by animal subjects, is dependent on three factors: (1) the iron content of the diet; (2) the liberation of iron contained in food by the digestive processes and its availability to be taken from the mucosa of the small intestine; and (3) intestinal conditions at the intraluminal level that greatly influence the final availability of iron. Moreover, there are two forms of iron: iron-heme and non-heme iron. The bioavailability of iron from these two iron forms is very different and greatly influences the potential absorption of iron in the diet.

Heme iron is only found in foods of animal origin, particularly in meat, where it is present in muscle hemoproteins; and it is more readily absorbed than the non-heme iron present in foods. Non-heme iron is found in cereals and vegetables and its absorption is generally low; only about 2% to 20% of the iron available from vegetable sources is absorbed. In fact, the absorption of non-heme iron depends on the composition of the diet as well as the oxidation state of the iron.

Absorption of iron by animals takes place mainly in the duodenum and in the proximal section of the jejunum. The iron is then transited through the enterocyte and is released as free iron into the blood. Ferrous (Fe2+) iron, being more soluble than ferric (Fe3+) iron, is more readily absorbed. Ferric iron is absorbed; however, only after it has been reduced to ferrous iron; this reduction process occurs in the stomach.

Iron deficiency in animals can be addressed via dietary supplements and food fortification. Examples of such dietary supplements include various ferrous citrate complexes, iron gluconate, iron pyrophosphate, and iron bis-glycinate.

U.S. Pat. No. 2,904,573 describes orally-administered human dietary supplements containing ferrous citrate complexes, including tri-ferrous di-citrate decahydrate. U.S. Pat. No. 2,904,573 teaches manufacture of tri-ferrous di-citrate decahydrate by mixing powdered iron with citric acid or monoferrous acid citrate, in water, under a nitrogen atmosphere, and heating the mixture to precipitate the product.

There remains a need for compositions comprising stable ferrous iron in a soluble form that is not susceptible to oxidation; e.g., for use as iron supplements; e.g., in the treatment of anemia. In addition, such compositions must be small enough (i.e., of sufficiently low molecular weight) to be absorbed by the human or animal gut.

### SUMMARY

Provided herein are compositions containing soluble ferrous ions that are resistant to oxidation (i.e., they remain stably in ferrous form), and are of sufficiently low molecular weight to be permeable to plant cells; e.g., by rhizospheric (e.g., root drench) or foliar application. The compositions can be used, inter alia, to provide ferrous ion to plants both prophylactically and therapeutically.

Accordingly, in certain embodiments, this disclosure provides a complex comprising a ferrous (Fe²⁺) ion and two molecules of pyruvate ion; i.e., a ferrous di-pyruvate (FDP) complex. In additional embodiments, this disclosure provides a complex containing three ferrous (Fe²⁺) ions and two citrate ions; i.e., a tri-ferrous di-citrate (TFDC) complex.

When present in the ferrous di-pyruvate and tri ferrous di-citrate complexes; ferrous ions resist oxidation to ferric (Fe³⁺) ions, remaining stably in the ferrous state for months. Accordingly, in some embodiments, this disclosure provides methods for preventing oxidation of ferrous ions by complexing ferrous ions with pyruvate ions at a 1:2 molar ratio of ferrous ion to pyruvate ion, and/or by complexing ferrous ions with citrate ions at a 3:2 molar ratio of ferrous ion to citrate ion.

Because they provide a stable source of soluble ferrous ions, the ferrous di-pyruvate (FDP) and tri-ferrous di-citrate (TFDC) complexes can be used to treat diseases and disorders of plants associated with iron deficiency. For example, the ferrous di-pyruvate and tri-ferrous di-citrate complexes can be used, individually or together, to treat chlorosis in plants, by contacting a diseased plant with FDP and/or TFDC. Contact can be by, for example, foliar application or rhizospheric application (e.g., root drench).

It has also been discovered that the FDP and TFDC complexes act as Fenton reagents; i.e., they react with hydrogen peroxide to produce reactive oxygen species. Accordingly, also provided are methods of manufacturing a Fenton reagent. In one embodiment, a Fenton reagent is manufactured by combining ferrous ions with pyruvate ions, in a 1:2 molar ratio of ferrous ion to pyruvate ion, in aqueous solution. In another embodiment, a Fenton reagent is manufactured by combining ferrous ions with citrate ions, in a 3:2 molar ratio of ferrous ion to citrate ion, in aqueous solution.

Also provided are methods for producing reactive oxygen species by contacting a FDP and/or a TFDC complex with hydrogen peroxide (H₂O₂). These methods can be conducted in vitro or can be conducted in vivo; i.e., in or on a plant.

Because of their ability to act as Fenton reagents and generate oxygen radicals, the FDP and TFDC complexes can also be used to treat microbial infections in plants such as those caused by, for example, bacteria or fungi. Accordingly, also provided herein are methods for treating bacterial infections in a plant by contacting the plant with FDP and/or TFDC. Contact can be by, for example, foliar application or rhizospheric application (e.g., root drench).

An exemplary bacterial infection having significant economic effects, which can be treated using the complexes described herein, is citrus greening disease (also known as Huanglongbing (“yellow dragon disease”) or HLB, citrus vein phloem degeneration (CVPD), yellow shoot disease, leaf mottle yellows, and citrus dieback), which is a vector-borne (e.g., Diaphorina citri) plant disease caused by Candidatus Liberibacter spp. bacteria.

An exemplary fungal infection having significant economic effects, which can be treated using the complexes described herein, is banana wilt, caused by the fungus Fusarium oxysporum.

Also provided herein are complexes containing a ferric (Fe³⁺) ion and three molecules of pyruvate ion; i.e., a ferric tri-pyruvate (FTP) complex. When present in a ferric tri-pyruvate complex, ferric ion is reduced, within days, to ferrous ion. Accordingly, this disclosure also provides methods for reducing ferric ion to ferrous ion by complexing the ferric ion with pyruvate ion at a 3:1 molar ratio of pyruvate ion to ferric ion. Also provided are methods for sustained release of ferrous ion to a subject by contacting the subject with a ferric tri-pyruvate complex. In certain embodiments, the subject is a plant and, in additional embodiments, the plant has an iron deficiency. In still additional embodiments, the iron deficiency results in cholorosis in the plant.

In additional embodiments, provided herein are methods for producing iron-fortified foodstuffs, by contacting a plant with a FDP complex, a TFDC complex and/or a FTP complex. Means of contacting include, for example, root drench and foliar application. The plant can be, for example, a vegetable, a fruit, a legume, or a grain.

Additionally provided herein are compositions containing soluble ferrous ions that are resistant to oxidation (i.e., they remain stably in ferrous form), and are of sufficiently low molecular weight to be absorbed by the animal gut and to be permeable to bacterial cells. Accordingly, in certain embodiments, this disclosure provides a complex comprising a ferrous (Fe²⁺) ion and two molecules of pyruvate ion; i.e., a ferrous di-pyruvate (FDP) complex. In additional embodiments, this disclosure provides a complex containing three ferrous (Fe²⁺) ions and two citrate ions; i.e., a tri-ferrous di-citrate (TFDC) complex.

The ferrous ion complexes described herein (FDP and TFDC complexes) can be used, inter alia, to provide ferrous ion to humans and animals both prophylactically and therapeutically. It has been discovered that the FDP and TFDC complexes act as Fenton reagents; i.e., they react with hydrogen peroxide to produce reactive oxygen species. Because Fenton reagents have anti-microbial activity; the ferrous ion complexes disclosed herein can be used as anti-microbial agents.

Also provided herein are complexes containing a ferric (Fe³⁺) ion and three molecules of pyruvate ion; i.e., a ferric tri-pyruvate (FTP) complex. When present in a ferric tri-pyruvate complex, ferric ion is reduced, within days, to ferrous ion. Similar to the FDP and TFDC complexes, the reduced FTP complex is a potent Fenton reagent that produces reactive oxygen species when reacted with hydrogen peroxide. Accordingly, FTP complexes, as described herein, can also be used as anti-microbial agents.

Also provided are methods for sustained release of ferrous ion to a subject by contacting the subject with a FTP complex. In certain embodiments, the subject is a human or other animal and, in additional embodiments, the subject is suffering from a microbial (e.g., bacterial, fungal) infection.

Also provided are methods for producing reactive oxygen species by contacting a FDP, TFDC and/or FTP complex with hydrogen peroxide (H₂O₂). These methods can be conducted in vitro or can be conducted in vivo; i.e., in a human or any other animal.

Because of their ability to act as Fenton reagents and generate oxygen radicals, the FDP, TFDC and FTP complexes can also be used to treat microbial infections in humans and animals such as those caused by, for example, pathogenic bacteria and fungi. Accordingly, also provided herein are methods for treating bacterial infections in humans and animals by contacting the subject with FDP, TFDC and/or FTP complexes. Contact can be by, e.g., ingestion or via injection.

Exemplary bacterial infections having significant economic effects, which can be treated using the complexes described herein, are Mycobacterium tuberculosis (MDR-TB), methicillin-resistant Staphylococcus aureus (MRSA), multidrug-resistant Streptococcus pneumoniae, vancomycin-resistant Enterococci (VRE), multidrug-resistant Acinetobacter baumannii, Pseudomonas aeruginosa, Enterobacteriaceae (including Klebsiella pneumoniae and Escherichia coli), Borellia burgdorferi (the causative agent of Lyme disease) and Clostridium difficile.

Exemplary fungal infections include those caused by Candida sp.; for example, Candida auris.

Accordingly, in certain embodiments, provided herein are methods for treating an infection in a subject, the methods comprising contacting the subject with a complex comprising a ferrous (Fe²⁺) ion, and two molecules of pyruvate ion (i.e. a ferrous di-pyruvate complex).

In additional embodiments, provided herein are methods for treating an infection in a subject, the methods comprising contacting the subject with a complex comprising three ferrous (Fe²⁺) ions, and two molecules of citrate ion (i.e., a tri-ferrous di-citrate complex).

In still further embodiments, provided herein are methods for treating an infection in a subject, the methods comprising contacting the subject with a complex comprising a ferric (Fe³⁺) ion, and three molecules of pyruvate ion (i.e. a ferric tri-pyruvate complex).

In any of the aforementioned embodiments, the subject can be a mammal, for example, a vertebrate, for example a primate, for example a human; and the infection can be systemic or cutaneous.

In any of the aforementioned embodiments, contacting can be by any method known in the art: for example, by ingestion (i.e., oral administration), injection or topical application.

The methods and compositions disclosed herein can be used for the treatment of microbial infections such as, for example, bacterial infections and fungal infections. Exemplary bacterial infections include those caused by Mycobacterium tuberculosis, Pseudomonas aeruginosa, Acinetobacter baumanii, Escherichia coli, Enterobacter cloacae, Staphylococcus aureus, Borellia burgdorferi and Clostridium difficile. Exemplary fungal infections include those caused by Candida sp.; for example, Candida auris.

In certain embodiments, the methods and compositions disclosed herein are used for the treatment of infections caused by microorganisms (e.g., bacteria, fungi) that are resistant to one or more antibiotics or anti-fungal agents.

Infections that can be treated using the methods and compositions disclosed herein include, without limitation, infections of the respiratory tract, infections of the urinary tract, infections of the reproductive tract, infections of the gastrointestinal tract, and infections of the skin.

Also provided herein are compositions containing soluble ferrous ions that are resistant to oxidation (i.e., they remain stably in ferrous form), and are of sufficiently low molecular weight to be absorbed by the animal gut. The compositions can be used, inter alia, to provide ferrous ion to humans and animals both prophylactically and therapeutically.

Accordingly, in certain embodiments, this disclosure provides a complex comprising a ferrous (Fe²⁺) ion and two molecules of pyruvate ion; i.e., a ferrous di-pyruvate (FDP) complex. In additional embodiments, this disclosure provides a complex containing three ferrous (Fe²⁺) ions and two citrate ions; i.e., a tri-ferrous di-citrate (TFDC) complex.

Because they provide a stable source of soluble ferrous ions, the ferrous di-pyruvate (FDP) and tri-ferrous di-citrate (TFDC) complexes can be used to treat diseases and disorders of humans and animals associated with iron deficiency. For example, the ferrous di-pyruvate and tri-ferrous di-citrate complexes can be used, individually or together, to treat iron deficiency (e.g., anemia) in humans and animals.

Also provided herein are complexes containing a ferric (Fe³⁺) ion and three molecules of pyruvate ion; i.e., a ferric tri-pyruvate (FTP) complex. When present in a ferric tri-pyruvate complex, ferric ion is reduced, within days, to ferrous ion. Accordingly, this disclosure also provides methods for reducing ferric ion to ferrous ion by complexing the ferric ion with pyruvate ion at a 3:1 molar ratio of pyruvate ion to ferric ion. Also provided are methods for sustained release of ferrous ion to a subject by contacting the subject with a FTP complex. In certain embodiments, the subject is a human or other animal and, in additional embodiments, the subject has an iron deficiency.

In certain embodiments, disclosed herein is a method for treatment of iron deficiency in a subject, wherein the method comprises contacting the subject with a complex comprising (a) a ferrous (Fe²⁺) ion, and (b) two molecules of pyruvate ion (a FDP complex).

In additional embodiments, disclosed herein is a method for treatment of iron deficiency in a subject, wherein the method comprises contacting the subject with a complex comprising (a) three ferrous (Fe²⁺) ions, and (b) two molecules of citrate ion (a TFDC complex).

In either of the foregoing embodiments, the subject can be an animal, e.g., a vertebrate; e.g., a primate; e.g., a human.

In certain embodiments, the iron deficiency results in anemia, and the complexes disclosed herein are used for treatment of anemia.

The complexes can be administered orally, e.g., as a pill or as part of a supplemented foodstuff. Thus, contacting can be by ingestion or other form of oral administration.

In certain embodiments, provided herein is a nutritional supplement comprising a complex comprising (a) a ferrous (Fe²⁺) ion, and (b) two molecules of pyruvate ion.

In additional embodiments, provided herein is a nutritional supplement comprising a complex comprising (a) three ferrous (Fe²⁺) ions, and (b) two molecules of citrate ion.

In further embodiments, provided herein is a method for sustained release of ferrous ion to a subject, the method comprising contacting the subject with a complex comprising (a) a ferric (Fe³⁺) ion, and (b) three molecules of pyruvate ion (a FTP complex). In certain embodiments, the subject is an animal, e.g., a vertebrate; e.g., a primate; e.g., a human.

In additional embodiments for sustained release of ferrous ion to a subject, the subject has an iron deficiency. In certain embodiments, the iron deficiency results in anemia, and the FTP complex is used for treatment of anemia.

The complexes can be administered orally, e.g., as a pill or as part of a supplemented foodstuff. Thus, contacting can be by ingestion or other form of oral administration. Contact can also be by topical application.

### BRIEF DESCRIPTION OF THE DRAWINGS

FIG. 1 shows chemical structures of the ferrous di-pyruvate complex, the tri-ferrous di-citrate complex and the ferric tri-pyruvate complex.

FIG. 2 shows the results of a test for Fenton activity of different iron complexes. Each tube contained one ml of test solution and 1 ml of 40% H₂O₂ and was incubated for one hour at ambient temperature. From left to right, the test solutions were water (negative control); 50 mM ferrous sulfate (positive control); 50 mM ferrous di-pyruvate complex; 50 mM tri-ferrous di-citrate complex; 50 mM mono-ferrous mono-citrate complex and 50 mM mono ferrous di-citrate complex. Formation of a precipitate (containing primarily ferric oxide and ferric hydroxide) indicates that the test solution acts as a Fenton reagent, and the amount of precipitate is an indication of the strength of Fenton activity.

FIG. 3 shows the results of a test for Fenton activity of the ferric tri-pyruvate complex. Each tube contained one ml of test solution and 1 ml of 40% H₂O₂ and was incubated for one hour at ambient temperature. From left to right, the test solutions were water (negative control); 50 mM ferrous di-pyruvate complex (FDP); 50 mM ferric tri-pyruvate complex (FTP) and 50 mM tri-ferrous di-citrate complex (TFDC). Formation of a precipitate (containing primarily ferric oxide and ferric hydroxide) indicates that the test solution acts as a Fenton reagent, and the amount of precipitate is an indication of the strength of Fenton activity.

FIG. 4 is a photograph of a chlorotic orange tree approximately three months after application of one liter of a 50 μM solution of ferrous di-pyruvate. Dried, stunted chlorotic leaves are visible at the left of the photograph; while new growth; characterized by shiny, bright-colored leaves; is visible at the bottom and at the right of the photograph.

### DETAILED DESCRIPTION

I. Definitions

The term “ferrous” refers to the Fe²⁺ ion, which is iron in the Iron (II) oxidation state.

The term “ferric” refers to the Fe³⁺ ion, which is iron in the Iron (III) oxidation state.

Accordingly, the ferrous ion is a more reduced form of iron than the ferric ion. Conversely, the ferric ion is a more oxidized form or iron than the ferrous ion.

The terms “ferrous ion complex” and “ferrous iron complex” are used herein interchangeably to refer to complexes of iron in the Iron (II) oxidation state (Fe²⁺) with an organic acid; e.g., a carboxylic acid.

The terms “ferric ion complex” and “ferric iron complex” are used herein interchangeably to refer to complexes of iron in the Iron (III) oxidation state (Fe³⁺) with an organic acid; e.g., a carboxylic acid.

II. Ferrous Ion Complexes

A. Ferrous Di-Pyruvate

1. Structure

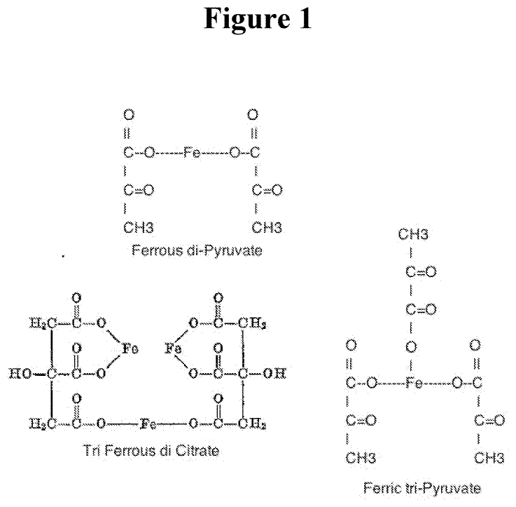

The structure of the ferrous di-pyruvate (FDP) complex is shown in FIG. 1. In the complex, each of the two positive charges of the ferrous ion is co-ordinated with a negatively-charged carboxyl group of a pyruvate anion, to form a complex containing a single ferrous ion and two pyruvate ions.

In certain embodiments, the concentration of ferrous ion in the FDP complex is at least 20% by mass, or at least 30% by mass, or at least 40% by mass, or at least 50% by mass, or at least 60% by mass, or at least 70% by mass, or at least 80% by mass, or at least 90% by mass, or at least 95% by mass, or at least 99% by mass. In other embodiments, the fraction of total iron in the FDP complex that is present as ferrous (Fe²⁺) iron is at least 20%, or at least 30%, or at least 40%, or at least 50%, or at least 60%, or at least 70%, or at least 80%, or at least 90%, or at least 95%, or at least 99%.

2. Methods for Making Ferrous Di-Pyruvate Complexes

In certain embodiments, FDP complexes are made by combining one equivalent of ferrous sulfate (heptahydrate) with two equivalents of sodium pyruvate in water or aqueous solution. See Example 2 below. In additional embodiments a FDP complex is made by combining two equivalents of pyruvic acid (titrated to pH7 to ionize the carboxyl groups) with one equivalent of ferrous ion, such as ferrous sulfate (heptahydrate).

When stored at ambient temperature, solutions of the FDP complex are stable for up to six months. See Example 4 below. This is in contrast to most other aqueous ferrous ion complexes, in which the ferrous ion is rapidly oxidized to the ferric form.

B. Tri-Ferrous Di-Citrate

1. Structure

The structure of the tri-ferrous di-citrate (TFDC) complex is shown in FIG. 1. The citrate anion contains three carboxyl groups which, at suitable pH, are all ionized. Two of the three ferrous ions in the tri-ferrous di-citrate complex interact electrostatically with two of the ionized carboxylic acid groups of a single citrate anion, while the third ferrous ion interacts electrostatically with the remaining carboxyl of each citrate ion. Tri-ferrous di-citrate has the chemical formula Fe₃(C₆H₅O₇)₂.10H₂O. It must be stored in the dark to prevent autodegradation.

In certain embodiments, the concentration of ferrous ion in the TFDC complex is at least 20% by mass, or at least 30% by mass, or at least 40% by mass, or at least 50% by mass, or at least 60% by mass, or at least 70% by mass, or at least 80% by mass, or at least 90% by mass, or at least 95% by mass, or at least 99% by mass. In other embodiments, the fraction of total iron in the TFDC complex that is present as ferrous (Fe²⁺) iron is at least 20%, or at least 30%, or at least 40%, or at least 50%, or at least 60%, or at least 70%, or at least 80%, or at least 90%, or at least 95%, or at least 99%.

2. Methods for Making Tri-Ferrous Di-Citrate Complexes

In certain embodiments, TFDC complexes are made by combining three equivalents of ferrous sulfate (heptahydrate) with two equivalents of citric acid monohydrate in water or aqueous solution at a pH of between 7.0 and 7.2. See Example 2 below. In additional embodiments that do not require deprotonation of citric acid, a TFDC complex is made by combining three equivalents of ferrous sulfate with two equivalents of tri-sodium citrate.

When stored in the dark at ambient temperature, solutions of TFDC complex are stable for up to six months. See Example 4 below. This is in contrast to most other aqueous ferrous ion complexes, in which the ferrous ion is rapidly oxidized to the ferric form.

C. Activities of the Ferrous Ion Complexes as Fenton Reagents

A Fenton Reaction occurs in a solution of ferrous ion and hydrogen peroxide (H₂O₂) in which the ferrous ion reacts with H₂O₂ to produce reactive oxygen species (e.g., hydroxyl radicals). Due to the existence of H₂O₂ as a by-product of metabolic activity in plants (e.g., photosynthesis) and animals (e.g., respiration), the FDP and TFDC complexes act as Fenton Reagents upon application to a plant, generating reactive oxygen species which can act to kill microorganisms.

Accordingly, in certain embodiments, the FDP and TFDC complexes disclosed herein are used to treat microbial infections in plants. Microbes include bacteria, fungi, protists, Archaea, oomycetes, and mycoplasma. The FDP and TFDC complexes provide a convenient, economical and safer alternative to antibiotics and fungicides for treatment of plant infections.

In additional embodiments, the FDP and TFDC complexes disclosed herein are used as therapeutic microbicides (e.g., for topical treatment of cutaneous infections) and as sterilizing agents (e.g., for surgical instruments and areas in which surgeries are performed).

D. Uses of Ferrous Ion Complexes in Plants

1. Bacterial Infections in Plants

Bacteria can be Gram-negative or Gram-positive. Exemplary bacteria that cause infections in plants include Candidatus, Erwinia, Pectobacterium, Pantoea, Agrobacterium, Pseudomonas, Ralstonia, Burkholderia, Acidovorax, Xanthomonas, Clavibacter, Streptomyces, Xylella, Spiroplasma, Phytoplasma, Liberibacter, and fastidious vascular bacteria. Exemplary bacterial disorders of plants include greening disease, galls, overgrowths, wilts (e.g., banana Xanthomonus wilt), leaf spots, specks, blight, soft rot, scabs and cankers.

In certain embodiments, the FDP and/or TFDC complex is used for treatment of citrus greening disease (also known as Huanglongbing (“yellow dragon disease”) or HLB, citrus vein phloem degeneration (CVPD), yellow shoot disease, leaf mottle yellows, and citrus dieback). Citrus greening disease (HLB) is distinguished by the common symptoms of yellowing of the veins and adjacent tissues; followed by splotchy mottling of the entire leaf, premature defoliation, dieback of twigs, decay of feeder rootlets and lateral roots, and decline in vigor, ultimately followed by the death of the entire plant. Affected trees have stunted growth, bear multiple off-season flowers (most of which fall off), and produce small, irregularly shaped fruit with a thick, pale peel that remains green at the bottom and tastes very bitter. Common symptoms can often be mistaken for nutrient deficiencies; however, the distinguishing factor between nutrient deficiencies is the pattern of symmetry. Nutrient deficiencies tend to be symmetrical along the leaf vein margin, while HLB has an asymmetrical yellowing around the vein. The most noticeable symptom of HLB is greening and stunting of the fruit, especially after ripening.

Citrus greening disease is caused by vector-borne (e.g., Diaphorina citri) infection of a plant with Candidatus Liberibacter spp. bacteria: Candidatus Liberibacter asiaticus (Asian type), Candidatus Liberibacter africanus (African type), and Candidatus Liberibacter americanus (American type). HLB-causing bacteria are phloem-localized and unculturable; because they cannot be cultured, it has proven difficult to develop methods for controlling citrus greening disease. The compositions disclosed herein provide new and convenient methods for treating citrus greening disease.

Citrus plants include, but are not limited to, orange, lemon, lime, grapefruit, tangerine, rough lemon (Citrus verrucosa), tankan orange (Citrus tankan), shekwasha (Citrus depressa Hayata), satsuma orange (Citrus unshiu) and the like.

In additional embodiments, ferrous di-pyruvate complexes and tri-ferrous di-citrate complexes, as disclosed herein, are used for treatment of disorders in plants resulting from iron deficiency such as, for example, chlorosis. Application of FDP or TFDC complexes to a plant also improves overall plant health by, for example, improving the ability of the plant to conduct photosynthesis, electron transport, amino acid biosynthesis, and the assimilation of nitrogen.

Symptoms of chlorosis generally appear on the youngest, newest leaves. The area between the leaf veins becomes pale yellow or white (interveinal chlorosis). Usually, no noticeable physical deformity occurs, but in severe cases the youngest leaves may be entirely white and stunted. Chlorosis can occur in crop plants (such as, for example, grapes, pecans and citrus) and in ornamentals, such as, for example, roses, mulberries, orchids and delphiniums. In iron deficient leaves, interveinal chlorotic lesions are angular and outlined by the leaf veins, whereas the chlorotic lesions in zinc deficient leaves are more rounded and the edges less sharp.

For treatment of chlorosis, the FDP complex is used at a concentration (of FDP complex) of 1 μM, 5 μM, 10 μM, 20 μM, 30 μM, 40 μM, 50 μM, 60 μM, 70 μM, 80 μM, 90 μM, 100 μM, 150 μM, 250 μM, 500 μM, or greater. In certain embodiments for treatment of chlorosis, the FDP complex is used at a concentration (of FDP complex) of up to 25 μM, up to 40 μM, up to 50 μM, up to 75 μM, up to 100 μM, up to 110 μM, up to 120 μM, up to 130 μM, up to 140 μM, up to 150 μM, up to 160 μM, up to 170 μM, up to 175 μM, or up to 177 μM. In certain embodiments for treatment of chlorosis, the FDP complex is used at a concentration (of FDP complex) between 10 μM and 500 μM, between 25 μM and 400 μM, between 50 μM and 250 μM, between 100 μM and 200 μM, between 10 μM and 100 μM, between 25 μM and 75 μM, between 40 μM and 60 μM or at a concentration (of FDP complex) of 50 μM.

The volume of FDP complex-containing solution applied to a plant for treatment of chlorosis depends on the concentration of the solution, the size of the plant and the route of administration, among others. For an exemplary foliar application, a 50 μM solution of FDP complex is applied, preferably to the undersides of the leaves, in a volume of 0.1 liter, 0.25 liter, 0.5 liter, 1 liter, 2, liters, 3, liters, 4 liters, 5 liters, 6 liters, 7 liters, 8 liters, 9 liters, 10 liters (or any fractional value therebetween) or more. For application to the rhizosphere (i.e., root drench), a volume of 1 liter, 2, liters, 3, liters, 4 liters, 5 liters, 6 liters, 7 liters, 8 liters, 9 liters, 10 liters (or any fractional value therebetween) or more, of a 50 μM solution can be used. Determination of other suitable concentrations and volumes is within the skill of the art.

The frequency of administration of FDP complex, for treatment of chlorosis, depends on the concentration of the solution, the size of the plant and the severity of the disorder. Administration, by either the foliar or rhizospheric route, can be conducted twice daily, daily, every other day, twice weekly, weekly, every two weeks, bimonthly, monthly, or on any other schedule.

It is within the skill of the art to modify; individually or in any combination; the concentration of FDP in a solution, the volume of solution applied to a plant, the route of application, and/or the frequency of application, based on, e.g., the size of the plant, the severity of disease, and/or the progress of recovery during treatment.

For treatment of chlorosis, the TFDC complex is used at a concentration (of TFDC complex) of 1 μM, 5 μM, 10 μM, 20 μM, 30 μM, 40 μM, 50 μM, 60 μM, 70 μM, 80 μM, 90 μM, 100 μM, 150 μM, 250 μM, 500 μM, or greater. In certain embodiments for treatment of chlorosis, the TFDC complex is used at a concentration (of TFDC complex) of up to 25 μM, up to 40 μM, up to 50 μM, up to 75 μM, up to 100 μM, up to 110 μM, up to 120 μM, up to 130 μM, up to 140 μM, up to 150 μM, up to 160 μM, up to 170 μM, up to 175 μM, or up to 177 μM. In certain embodiments for treatment of chlorosis, the TFDC complex is used at a concentration (of TFDC complex) between 10 μM and 500 μM, between 25 μM and 400 μM, between 50 μM and 250 μM, between 100 μM and 200 μM, between 10 μM and 100 μM, between 25 μM and 75 μM, between 40 μM and 60 μM or at a concentration (of TFDC complex) of 50 μM.

The volume of TFDC complex-containing solution applied to a plant for treatment of chlorosis depends on the concentration of the solution, the size of the plant and the route of administration, among others. For foliar application, a 50 μM solution of TFDC complex is applied, preferably to the undersides of the leaves, in a volume of 0.1 liter, 0.25 liter, 0.5 liter, 1 liter, 2, liters, 3, liters, 4 liters, 5 liters, 6 liters, 7 liters, 8 liters, 9 liters, 10 liters (or any fractional value therebetween) or more. For application to the rhizosphere (i.e., root drench), a volume of 1 liter, 2, liters, 3, liters, 4 liters, 5 liters, 6 liters, 7 liters, 8 liters, 9 liters, 10 liters (or any fractional value therebetween) or more, of a 50 μM solution can be used.

The frequency of administration of TFDC complex, for treatment of chlorosis, depends on the concentration of the solution, the size of the plant and the severity of the disorder. Administration, by either the foliar or rhizospheric route, can be conducted twice daily, daily, every other day, twice weekly, weekly, every two weeks, bimonthly, monthly, or on any other schedule.

It is within the skill of the art to modify; individually or in any combination; the concentration of TFDC in a solution, the volume of solution applied to a plant, the route of application, and/or the frequency of application, based on, e.g., the size of the plant, the severity of disease, and/or the progress of recovery during treatment.

2. Fungal Infections in Plants

Approximately 85% of plant disorders are caused by fungi. Such disorders include powdery mildew, downy mildew, verticilium wilt, leaf rust, stem rust, root rot, stem rot, fruit rot (e.g., brown rot) and sclerotinia. Exemplary fungi that cause infections in plants include Fusarium (Banana Wilt disease), Microsphaera (e.g., Microsphaera alni), Verticillium (e.g., Verticillium albo-atrum, Verticillium dahliae), Tilletia, Plasmopara, Puccinia, Aspergillus, Amanita, and Rhizoctonia.

Fungus-like organisms (FLOs) such as Pythium and Phytophthora, responsible for plant disorders such as downy mildew, can also be treated with the FDP and TFDC complexes disclosed herein.

3. Protist Infections in Plants

Plant disorders caused by protists include coffee phloem necrosis, palm wilt, coconut wilt, oil palm wilt, clubroot, crook root and powdery scab. Exemplary protists that cause infections in plants include Phytomonas (e.g., P. leptovasorum, P. staheli, P. francai, P. serpens), Polymyxa (e.g., Px. graminis, Px. betae), Phytomyxea, Labyrinthula (e.g., L. zosterae, L. terrestris), Spongospora (e.g., S. subterranea) and Plasmodiophora (e.g., Pl. brassicae).

4. Oomycete Infections in Plants

Plant disorders caused by oomycetes include sudden oak death, late blight of potato, red rot disease and. Targets of oomycete infections include red algae and brown algae, much of which is used for human consumption in the form of Nori (sushi wrap). Red and brown algae are also used in the production of fertilizers, animal feed and biofuels. Exemplary oomycetes that cause disorders in plants include Pythium porphyrae, Eurychasma dicksonii, and Olpidiopsis spp.

5. Mycoplasma Infections in Plants

Plant disorders caused by mycoplasma include yellows disease, phyllody, and stolbur. Exemplary mycoplasma that exist intracellularly in plant phloem include spiroplasmas and mycoplasma-like organisms (MLOs). Mycoplasma of the genera Spiroplasma (e.g. Spiroplasma citri), Mycoplasma, and Acholeplasma are also found residing extracellularly on the surface of plants.

E. Therapeutic Uses of Ferrous Ion Complexes

In certain embodiments, the FDP and TFDC complexes disclosed herein are used to treat microbial (e.g., bacterial, fungal) infections in human and other animals. Microbes include bacteria, fungi, mycoplasma, protists and Archaea. The FDP and TFDC complexes provide a convenient, economical and safer alternative to antibiotics for treatment of bacterial infections in humans and other animals.

Bacteria can be Gram-negative or Gram-positive. Furthermore, the bacteria can be drug resistant. Exemplary bacterial infections having significant economic effects, which can be treated using the complexes described herein, include those caused by Mycobacterium tuberculosis (MDR-TB), methicillin-resistant Staphylococcus aureus (MRSA), multidrug-resistant Streptococcus pneumoniae, vancomycin-resistant Enterococci (VRE), multidrug-resistant Acinetobacter baumannii, Pseudomonas aeruginosa, Enterobacteriaceae (including Klebsiella pneumoniae and Escherichia coli), Borellia burgdorferi and Clostridium difficile.

Exemplary fungal infections that can be treated using the complexes described herein include those caused by Candida sp., for example, Candida auris.

For treatment of microbial infections, the FDP complex and/or the TFDC complex are used at concentrations (of complex) of 1 μM, 5 μM, 10 μM, 20 μM, 30 μM, 40 μM, 50 μM, 60 μM, 70 μM, 80 μM, 90 μM, 100 μM, 150 μM, 250 μM, 500 μM, or greater. In certain embodiments for treatment of infection, the complexes are used at a concentration (of complex) of up to 25 μM, up to 40 μM, up to 50 μM, up to 75 μM, up to 100 μM, up to 110 μM, up to 120 μM, up to 130 μM, up to 140 μM, up to 150 μM, up to 160 μM, up to 170 μM, up to 175 μM, or up to 177 μM. In certain embodiments for treatment of infection, the complexes are used at a concentration (of complex) between 10 μM and 500 μM, between 25 μM and 400 μM, between 50 μM and 250 μM, between 100 μM and 200 μM, between 10 μM and 100 μM, between 25 μM and 75 μM, between 40 μM and 60 μM or at a concentration (of complex) of 50 μM.

It is within the skill of the art to modify; individually or in any combination; the concentration of the FDP complex and/or the TFDC complex in a medicament for treatment of infection, the route of application, and/or the frequency of application, based on, e.g., the size and/or weight of the subject, the severity of the infection, and/or the progress of recovery during treatment.

F. Uses of Ferrous Ion Complexes as Antiseptics and Sanitizing Agents

Bacterial vegetative cell and spores are highly susceptible to free radicals. Accordingly, the FDP and TFDC complexes can be used as antiseptics, sanitizing agents, or sterilizing agents, for killing bacterial cells and spores.

Accordingly, in one embodiment, a solution of hydrogen peroxide (e.g., 5 mM, 10 mM, 20 mM, 25 mM, 30 mM, 40 mM, 50 mM, 60 mM, 70 mM, 80 mM, 90 mM, 100 mM, 125 mM, 150 mM, 175 mM, 200 mM or more) is applied to a surface that needs to be decontaminated. A solution of FDP (e.g., 1 mM, 2 mM, 3 mM, 4 mM, 5 mM, 6 mM, 7 mM, 8 mM, 9 mM, 10 mM, 12.5 mM, 15 mM, 20 mM, 25 mM or more) is then applied to the surface. In the presence of the H₂O₂ previously applied to the surface, the FDP acts as a Fenton reagent, generating reactive oxygen species that kill bacteria. Accordingly, after a period of time (e.g., 5 minutes, 10 minutes, 15 minutes, 20 minutes, 25 minutes, 30 minutes, 35 minutes, 40 minutes, 45 minutes, 50 minutes, 55 minutes, 60 minutes, 65 minutes, 70 minutes, 75 minutes, 80 minutes, 85 minutes, 90 minutes, 95 minutes, 100 minutes, 105 minutes, 110 minutes, 115 minutes, 120 minutes or more) the surface is sterile.

Surfaces can be surgical gowns, surgical gloves, surgical instruments, surgical beds (i.e., operating tables), floors and walls of a operating theater, and healthcare facilities in general.

Treatments for topical bacterial and fungal infections are conducted in a similar manner. For example, a wound is swabbed, first with H₂O₂ (e.g., at a concentration of 1 mM, 2 mM, 2.5 mM, 3 mM, 4 mM, 5 mM, 6 mM, 7 mM, 8 mM, 9 mM, 10 mM, 12.5 mM, 15 mM, 17.5 mM, 20 mM or more) and subsequently with FDP or TFDC (e.g., at a concentration of 1 μM, 2 μM, 3 μM, 4 μM, 5 μM, 6 μM, 7 μM, 8 μM, 9 μM, 10 μM, 12.5 μM, 15 μM, 20 μM, 25 μM, 30 μM, 40 μM, 50 μM, 75 μM, 100 μM, or more). Such methods are useful for treatment of, e.g., antibiotic-resistant bacterial skin infections, such as methicillin-resistant Staphylococcus aureus (MRSA). The methods can also be used prophylactically, for example, by treatment of the epidermis of a surgical patient with H₂O₂ and FDP (or TFDC) prior to surgery.

There are similar veterinary application for the aforementioned methods of sequential application of H₂0₂ then FDP (or TFDC), for example, for treating ear infections, wounds and skin infections.

III. Ferric Ion Complexes

A. Structure

The structure of the ferric tri-pyruvate (FTP) complex is shown in FIG. 1. In the complex, each of the three positive charges of the ferric ion is co-ordinated with a negatively-charged carboxyl group of a pyruvate anion, to form a complex containing a single ferric ion and three pyruvate ions.

In certain embodiments, the concentration of ferric ion in the FTP complex is at least 20% by mass, or at least 30% by mass, or at least 40% by mass, or at least 50% by mass, or at least 60% by mass, or at least 70% by mass, or at least 80% by mass, or at least 90% by mass, or at least 95% by mass, or at least 99% by mass. In other embodiments, the fraction of total iron in the FTP complex that is present as ferric (Fe³⁺) iron is at least 20%, or at least 30%, or at least 40%, or at least 50%, or at least 60%, or at least 70%, or at least 80%, or at least 90%, or at least 95%, or at least 99%.

B. Methods for Making Ferric Tri-Pyruvate Complexes

In certain embodiments, FTP complexes are made by combining one equivalent of anhydrous ferric chloride with three equivalents of sodium pyruvate in water or aqueous solution. See Example 5 below. In additional embodiments, a FTP complex is made by deprotonating pyruvic acid (e.g., by titration with NaOH or KOH) and combining the deprotonated pyruvic acid with a source of ferric ion such as, for example, ferric chloride (FeCl₃).

C. Stability of Ferric Tri-Pyruvate Complexes

Ferric ions, as part of a ferric tri-pyruvate complex, are relatively unstable, undergoing reduction to ferrous ions under ambient conditions. Within one day after formation of the complex, approximately one-fifth of ferric ions have been reduced to ferrous; after one week, essentially all iron is in the ferrous oxidation state, in the form of the ferrous di-pyruvate complex. See Example 6 below.

Accordingly, ferric tri-pyruvate complexes can be used for reduction of Fe(III) to Fe(II) under relatively gentle conditions. In addition, FTP complexes can be used for sustained release of ferrous ion to a subject; e.g., a plant. Sustained release is advantageous for situations in which large amounts of Fe(II) are required, but the subject is sensitive to a large bolus of ferrous ion. Sustained release over a given time period (e.g., one week) is also more convenient than repeated dosages (e.g., daily) during the same time period.

For sustained release of ferrous ion to a plant or animal, the FTP complex is used at a concentration (of FTP complex) of 1 μM, 5 μM, 10 μM, 20 μM, 30 μM, 40 μM, 50 μM, 60 μM, 70 μM, 80 μM, 90 μM, 100 μM, 150 μM, 250 μM, 500 μM, or greater. In certain embodiments for treatment of chlorosis, the FTP complex is used at a concentration (of FTP complex) of up to 25 μM, up to 40 μM, up to 50 μM, up to 75 μM, up to 100 μM, up to 110 μM, up to 120 μM, up to 130 μM, up to 140 μM, up to 150 μM, up to 160 μM, up to 170 μM, up to 175 μM, or up to 177 μM. In certain embodiments for treatment of chlorosis, the FTP complex is used at a concentration (of FTP complex) between 10 μM and 500 μM, between 25 μM and 400 μM, between 50 μM and 250 μM, between 100 μM and 200 μM, between 10 μM and 100 μM, between 25 μM and 75 μM, between 40 μM and 60 μM or at a concentration (of FTP complex) of 50 μM.

The volume of FTP complex-containing solution applied to a plant for sustained release of Fe²⁺ ion depends on the concentration of the solution, the size of the plant and the route of administration, among others. For foliar application, a 50 μM solution of FTP complex is applied, preferably to the undersides of the leaves, in a volume of 0.1 liter, 0.25 liter, 0.5 liter, 1 liter, 2, liters, 3, liters, 4 liters, 5 liters, 6 liters, 7 liters, 8 liters, 9 liters, 10 liters (or any fractional value therebetween) or more. For application to the rhizosphere (i.e., root drench), a volume of 1 liter, 2, liters, 3, liters, 4 liters, 5 liters, 6 liters, 7 liters, 8 liters, 9 liters, 10 liters (or any fractional value therebetween) or more, of a 50 μM solution can be used.

The frequency of administration of FTP complex, for sustained release of Fe²⁺ ion, depends on the concentration of the solution, the size of the plant and the severity of the disorder. Administration, by either the foliar or rhizospheric route, can be conducted twice daily, daily, every other day, twice weekly, weekly, every two weeks, bimonthly, monthly, or on any other schedule.

D. FTP Complexes as a Source of Fenton Activity

Because the ferric tri-pyruvate (FTP) complex is fairly rapidly converted to the ferrous di-pyruvate (FDP) complex, and the FDP complex is a Fenton reagent, the FTP complex can be used as a source of Fenton activity.

Accordingly, in certain embodiments, the FTP complexes disclosed herein are used to treat microbial infections in plants; as described above for the FDP and TFDC complexes.

Furthermore, due to the existence of H₂O₂ in animals as a by-product of metabolic activity (e.g., respiration), Fenton activity (i.e., generation of reactive oxygen species) ensues upon application of the FTP complex to a subject (e.g., human, animal), generating reactive oxygen species which can act to kill microorganisms.

Accordingly, in certain embodiments, the FTP complex disclosed herein is used to treat microbial (e.g., bacterial, fungal) infections in human and other animals, as described above for the FDP and TFDC complexes. Microbes include bacteria, fungi, mycoplasma, protists and Archaea. The FTP complex provides a convenient, economical and safer alternative to antibiotics for treatment of bacterial infections in humans and other animals.

It is within the skill of the art to modify; individually or in any combination; the concentration of the FTP complex in a medicament for treatment of infection, the route of application, and/or the frequency of application, based on, e.g., the size and/or weight of the subject, the severity of the infection, and/or the progress of recovery during treatment.

IV. Pharmaceutical Compositions and Formulations

Various pharmaceutical compositions and techniques for their preparation and use are known to those of skill in the art in light of the present disclosure. For a detailed listing of suitable pharmacological compositions and techniques for their administration one may refer to texts such as Remington's Pharmaceutical Sciences, 17th ed. 1985; Brunton et al., “Goodman and Gilman's The Pharmacological Basis of Therapeutics,” McGraw-Hill, 2005; University of the Sciences in Philadelphia (eds.), “Remington: The Science and Practice of Pharmacy,” Lippincott Williams & Wilkins, 2005; and University of the Sciences in Philadelphia (eds.), “Remington: The Principles of Pharmacy Practice,” Lippincott Williams & Wilkins, 2008.

Pharmaceutical compositions can be formulated by standard techniques using one or more physiologically acceptable carriers or excipients. The formulations can contain a buffer and/or a preservative. The compounds and their physiologically acceptable salts and solvates can be formulated for administration by any suitable route, including via inhalation, topically, nasally, orally, parenterally (e.g., intravenously, intraperitoneally, intravesically or intrathecally) or rectally in a vehicle comprising one or more pharmaceutically acceptable carriers, the proportion of which is determined by the solubility and chemical nature of the compound, chosen route of administration and standard biological and pharmacological practices.

Additional routes of administration include, but are not limited to, transdermal, parenteral, intravenous, intra-arterial, subcutaneous, intramuscular, intracranial, intraorbital, ophthalmic, intraventricular, intracapsular, intraspinal, intracisternal, intraperitoneal, intracerebroventricular, intrathecal, intranasal, aerosol, by suppositories, or by oral administration.

Pharmaceutical compositions can include effective amounts of one or more compound(s) described herein together with, for example, pharmaceutically acceptable diluents, preservatives, solubilizers, emulsifiers, adjuvants and/or other carriers. Such compositions can include diluents of various buffer content (e.g., TRIS or other amines, carbonates, phosphates, amino acids, for example, glycinamide hydrochloride (especially in the physiological pH range), N-glycylglycine, sodium or potassium phosphate (dibasic, tribasic), etc., TRIS-HCI or TRIS-acetate), pH and ionic strength; additives such as detergents and solubilizing agents (e.g., surfactants such as Pluronics, Tween 20, Tween 80, Polysorbate 80, Cremophor, polyols such as polyethylene glycol, propylene glycol, etc.), anti-oxidants (e.g., ascorbic acid, sodium metabisulfite), preservatives (e.g., Thimersol, benzyl alcohol, parabens, etc.) and bulking substances (e.g., sugars such as sucrose, lactose, mannitol, polymers such as polyvinylpyrrolidones or dextran, etc.); and/or incorporation of the material into particulate preparations of polymeric compounds such as polylactic acid, polyglycolic acid, etc. or into liposomes. Hyaluronic acid can also be used.

Such compositions can be employed to influence the physical state, stability, rate of in vivo release, and rate of in vivo clearance of a compound described herein. See, e.g., Remington's Pharmaceutical Sciences, 18th Ed. (1990, Mack Publishing Co., Easton, Pa. 18042) pages 1435-1712 which are hereby incorporated herein by reference. The compositions can, for example, be prepared in liquid form, or can be in dried powder, such as lyophilized form. Particular methods of administering such compositions are described infra.

If a buffer is to be included in the formulations described herein, the buffer can be selected from sodium acetate, sodium carbonate, citrate, glycylglycine, histidine, glycine, lysine, arginine, sodium dihydrogen phosphate, disodium hydrogen phosphate, sodium phosphate, and tris(hydroxymethyl)-aminomethane, or mixtures thereof. The buffer can also be glycylglycine, sodium dihydrogen phosphate, disodium hydrogen phosphate, and sodium phosphate or mixtures thereof. If a pharmaceutically acceptable preservative is to be included in a formulation of one of the compounds described herein, the preservative can be selected from phenol, m-cresol, methyl p-hydroxybenzoate, propyl p-hydroxybenzoate, 2-phenoxyethanol, butyl p-hydroxybenzoate, 2-phenylethanol, benzyl alcohol, chlorobutanol, and thiomerosal, or mixtures thereof. The preservative can also be phenol or m-cresol.

The terms “pharmaceutically acceptable” and “therapeutically acceptable” refer to molecular entities and compositions that are physiologically tolerable and preferably do not typically produce an allergic or similar untoward reaction, such as gastric upset, dizziness and the like, when administered to a subject (e.g., a human or an animal).

In some embodiments, the compounds described herein can be administered by any suitable route, including, but not limited to, via inhalation, topically, nasally, orally, parenterally (e.g., intravenously, intraperitoneally, intravesically or intrathecally) or rectally in a vehicle comprising one or more pharmaceutically acceptable carriers, the proportion of which is determined by the solubility and chemical nature of the compound, chosen route of administration and standard practice. Administration of the compounds described herein can be carried out using any method known in the art. For example, administration may be transdermal, parenteral, intravenous, intraarterial, subcutaneous, intramuscular, intracranial, intraorbital, ophthalmic, intraventricular, intracapsular, intraspinal, intracisternal, intraperitoneal, intracerebroventricular, intrathecal, intranasal, aerosol, by suppositories, or by oral administration. A pharmaceutical composition of the compounds described herein can be for administration for injection, or for oral, pulmonary, nasal, transdermal, or ocular administration.

Exemplary formulations include, but are not limited to, those suitable for parenteral administration, e.g., intrapulmonary, intravenous, intra-arterial, intra-ocular, intra-cranial, sub-meningial, or subcutaneous administration, including formulations encapsulated in micelles, liposomes or drug-release capsules (active agents incorporated within a biocompatible coating designed for slow-release); ingestible formulations; formulations for topical use, such as eye drops, creams, ointments and gels; and other formulations such as inhalants, aerosols and sprays. The dosage of the compositions of the disclosure will vary according to the extent and severity of the need for treatment, the activity of the administered composition, the general health of the subject, and other considerations well known to the skilled artisan.

In additional embodiments, the compositions described herein are delivered locally. Localized delivery allows for the delivery of the composition non-systemically, thereby reducing the body burden of the composition as compared to systemic delivery. Such local delivery can be achieved, for example, through the use of various medically implanted devices including, but not limited to, stents and catheters, or can be achieved by inhalation, injection or surgery. Methods for coating, implanting, embedding, and otherwise attaching desired agents to medical devices such as stents and catheters are established in the art and contemplated herein.

For oral administration, the pharmaceutical composition of the compounds described herein can be a liquid or can be formulated in unit dosage forms such as capsules or tablets. The tablets or capsules can be prepared by conventional means with pharmaceutically acceptable excipients, including binding agents, for example, pregelatinised maize starch, polyvinylpyrrolidone, or hydroxypropyl methylcellulose; fillers, for example, lactose, microcrystalline cellulose, or calcium hydrogen phosphate; lubricants, for example, magnesium stearate, talc, or silica; disintegrants, for example, potato starch or sodium starch glycolate; or wetting agents, for example, sodium lauryl sulfate.

Tablets can be coated by methods well known in the art. Liquid preparations for oral administration can take the form of, for example, solutions, syrups, or suspensions, or they can be presented as a dry product for constitution with water or other suitable vehicle before use. Such liquid preparations can be prepared by conventional means with pharmaceutically acceptable additives, for example, suspending agents, for example, sorbitol syrup, cellulose derivatives, or hydrogenated edible fats; emulsifying agents, for example, lecithin or acacia; non-aqueous vehicles, for example, almond oil, oily esters, ethyl alcohol, or fractionated vegetable oils; and preservatives, for example, methyl or propyl-p-hydroxybenzoates or sorbic acid. The preparations can also contain buffer salts, flavoring, coloring, and/or sweetening agents as appropriate. If desired, preparations for oral administration can be suitably formulated to give controlled release of the active compound.

The compounds described herein can also include derivatives referred to as prodrugs, which can be prepared by modifying functional groups present in the compounds in such a way that the modifications are removed (e.g., cleaved), either in routine manipulation or in vivo, to regenerate the parent compounds. Examples of prodrugs include compounds as described herein that contain one or more molecular moieties appended to a hydroxyl, amino, sulfhydryl, or carboxyl group of the compound, and that when administered to a patient, are cleaved in vivo to form the free hydroxyl, amino, sulfhydryl, or carboxyl group, respectively. Examples of prodrugs include, but are not limited to, acetate, formate and benzoate derivatives of alcohol and amine functional groups in the compounds described herein. Preparation and use of prodrugs is discussed, for example, in T. Higuchi et al., “Pro-drugs as Novel Delivery Systems,” Vol. 14 of the A.C.S. Symposium Series, and in “Bioreversible Carriers in Drug Design,” ed. Edward B. Roche, American Pharmaceutical Association and Pergamon Press, 1987, both of which are incorporated herein by reference in their entireties.

V. Dosages

The compounds described herein can be administered to a subject (e.g., animal or plant) at therapeutically effective doses to prevent, treat, or control one or more diseases and/or disorders mediated, in whole or in part, by a microbial (e.g., bacterial, fungal) infection. The compounds can also be administered, either alone or in combination with other substances, for treatment of microbial infections. Pharmaceutical compositions comprising one or more of compounds described herein can be administered to a patient in an amount sufficient to elicit an effective protective, therapeutic response in a subject. An amount adequate to accomplish any of these is defined as a “therapeutically effective dose.” A therapeutically effective dose is determined by the efficacy of the particular compound employed and the condition of the subject, as well as the body weight or surface area of the region to be treated and the severity of the disorder. The size of the dose can also be influenced by the existence, nature, and extent of any adverse effects that accompany the administration of a particular compound or vector in a particular subject.

Toxicity and therapeutic efficacy of compounds can be determined by standard pharmaceutical procedures in cell cultures or experimental animals, for example, by determining the LD₅₀ (the dose lethal to 50% of the population) and the ED₅₀ (the dose that is therapeutically effective in 50% of the population). The dose ratio between toxic and therapeutic effects is the therapeutic index and can be expressed as the ratio, LD₅₀/ED₅₀. In some embodiments, compounds that exhibit large therapeutic indices are used. While compounds that exhibit toxic side effects can be used, care should be taken to design a delivery system that targets such compounds to the site of affected tissue to minimize potential damage to normal cells and, thereby, reduce side effects.

The data obtained from cell culture assays and animal studies can be used to formulate a dosage range for use in humans. In some embodiments, the dosage of such compounds lies within a range of circulating concentrations that include the ED₅₀ and that exhibits little or no toxicity. The dosage can vary within this range depending upon the dosage form employed and the route of administration and other factors, including the condition of the subject. For any compound described herein, the therapeutically effective dose can be estimated initially from cell culture assays. A dose can be formulated in animal models to achieve a circulating plasma concentration range that includes the IC₅₀ (the concentration of the test compound that achieves a half-maximal inhibition of symptoms) as determined in cell culture. Such information can be used to determine more accurately useful doses in humans. Levels in plasma can be measured, for example, by high performance liquid chromatography (HPLC). In general, the dose equivalent of a complex as described herein is from about 1 ng/kg to 10 mg/kg for a typical subject. In certain embodiments, the dose level is between 10 ng/kg and 1 mg/kg; in other embodiments, between 100 ng/kg and 0.1 mg/kg; in other embodiments, between 1 μg/kg and 10 μg/kg. In additional embodiments, the dose range for a complex as described herein is between 1-100 ng/kg, or 10-1,000 ng/kg, or 0.1-10 μg/kg, or 10-100 μg/kg, or 0.1-1 mg/kg, or 1-10 mg/kg.

The amount and frequency of administration of the compounds described herein and/or the pharmaceutically acceptable salts thereof is regulated according to the judgment of the attending clinician considering such factors as age, condition and size of the subject as well as severity of the symptoms being treated. An ordinarily skilled physician or veterinarian can readily determine and prescribe an effective amount of a compound suitable to prevent, counter or arrest the progress of the condition. In general, it is contemplated that an effective amount would be from 0.001 mg/kg to 10 mg/kg body weight, and in particular from 0.01 mg/kg to 1 mg/kg body weight. It may be appropriate to administer the required dose as two, three, four or more sub-doses at appropriate intervals throughout the day. Said sub-doses can be formulated as unit dosage forms, for example, containing 0.01 to 500 mg, and in particular 0.1 mg to 200 mg of active ingredient per unit dosage form.

VI. Kits

Another aspect of the present disclosure relates to kits for carrying out the administration of ferrous and ferric complexes to a subject (e.g., a plant or an animal). In one embodiment, a kit comprises a composition comprising one or more of a FDP complex, a TFDC complex and/or a FTP complex, formulated as appropriate (e.g., in a pharmaceutical carrier), in one or more separate pharmaceutical preparations. Kits can also contain devices for administration of the composition(s) and/or instructions for use.

VII. Enhancing Iron Content of Foodstuffs

Because the FDP and TFDC complexes provide stable ferrous ions, and the FTP complex is converted into ferrous ions; these complexes can be applied to healthy plants to enhance the iron content of the plant. Food plants include, for example, vegetables, fruits, legumes and grains. Application can be by, for example, foliar application or root drench. Plants with enhanced iron content are useful as foodstuffs. Any plant can be treated (i.e., contacted with) a ferric or ferrous ion complex as described herein (i.e., FDP, TFDC and/or FTP) so that the iron content of the leaves, roots (e.g., tubers) and/or fruit is higher than the iron content of the leaves, roots and/or fruit of a plant not so treated.

VIII. Nutritional Applications

A. Ferrous Di-Pyruvate

Ferrous di-pyruvate complexes as disclosed herein are used for treatment of disorders in humans or any other animal resulting from iron deficiency such as, for example, anemia. Application of FDP complexes to humans or any other animal also improves overall health by, for example, improving the ability of the animal to conduct electron transport, amino acid biosynthesis, and the transport of oxygen.

Since iron is absorbed via the gut, the FDP complex is administered as an oral dietary supplement or as a food additive.

For treatment of anemia, the FDP complex is used at a concentration (of FDP complex) of, for example, between 50 μmoles and 250 μmoles (or any integral value therebetween) per dose.

The frequency of administration of FDP complex, for treatment of anemia, depends on the concentration of the solution, the weight of the subject and the severity of the disorder. Administration, by either dietary supplement or food additive, can be conducted once daily, daily, every other day, twice weekly, weekly, every two weeks, bimonthly, monthly, or on any other schedule.

It is within the skill of the art to modify; individually or in any combination; the concentration of FDP in a solution, the volume of solution applied to a human or other animal, the route of application, and/or the frequency of application, based on, e.g., the size of the subject, the severity of disease, and/or the progress of recovery during treatment.

B. Tri-Ferrous Di-Citrate

The tri-ferrous di citrate complex as disclosed herein is useful for treatment of disorders in humans or any other animal resulting from iron deficiency such as, for example, anemia. Application of TFDC complexes to humans or any other animal also improves overall health by, for example, improving the ability of the animal to conduct electron transport, amino acid biosynthesis, and the transport of oxygen.

Since iron is absorbed via the gut, the TFDC complex is administered as an oral dietary supplement or as a food additive.

For treatment of anemia, the TFDC complex is used at a concentration (of TFDC complex) of, for example, between 50 μmoles and 250 μmoles (or any integral value therebetween) per dose.

The frequency of administration of TFDC complex, for treatment of anemia, depends on the concentration of the solution, the weight of the subject and the severity of the disorder. Administration, by either dietary supplement or food additive, can be conducted once daily, daily, every other day, twice weekly, weekly, every two weeks, bimonthly, monthly, or on any other schedule.

It is within the skill of the art to modify; individually or in any combination; the concentration of TFDC in a solution, the volume of solution applied to a human or other animal, the route of application, and/or the frequency of application, based on, e.g., the size of the subject, the severity of disease, and/or the progress of recovery during treatment.

C. Ferric Tri-Pyruvate

Because the FTP complex is capable of sustained release of ferrous iron, it, too can be used in the treatment of iron deficiencies in a subject (e.g., a human or an animal).

For sustained release of ferrous ion to a human or other animal, the FTP complex is administered at a concentration (of FTP complex) of, for example, between 50 μmoles and 250 μmoles (or any integral value therebetween) per dose or greater. In certain embodiments for treatment of anemia, the FTP complex is used at a concentration (of FTP complex) of between 50 μmoles and 250 μmoles or greater.

The volume of FTP complex-containing solution applied to a human or other animal for sustained release of Fe²⁺ ion depends on the concentration of the solution, the size of the subject and the route of administration, among others.

The frequency of administration of FTP complex, for sustained release of Fe²⁺ ion, depends on the concentration of the solution, the size of the subject and the severity of the disorder. Administration, via, e.g., an oral route, can be conducted twice daily, daily, every other day, twice weekly, weekly, every two weeks, bimonthly, monthly, or on any other schedule.

It is within the skill of the art to modify; individually or in any combination; the concentration of FTP in a solution, the volume of solution applied to a subject, the route of application, and/or the frequency of application, based on, e.g., the size of the subject, the severity of disease, and/or the progress of recovery during treatment.

### EXAMPLES

### Example 1

### Measurement of Iron Concentrations

1,10-phenanthroline is a colorless reagent that forms a red solution with ferrous (Fe²⁺) ions at a ratio of three moles 1, 10-phenanthroline to one mole ferrous ion. Ferrous ion concentration was determined by measuring absorbance at 510 nm after reaction of test solutions with 1,10-phenanthroline. A standard curve was constructed by measuring absorbance of serial dilutions of a 1 mM solution of ferrous ammonium sulfate, and plotting absorbance vs. ferrous ion concentration. The 1, 10-phenanthroline reagent is highly selective for ferrous (Fe²⁺) ion and does not form a red complex when reacted with ferric (Fe³⁺) ion.

Total iron (ferric+ferrous) in solution was determined by reducing all ferric ion to ferrous ion prior to reaction with 1,10-phenanthroline. Ferric ion was reduced to ferrous ion by reaction with hydroxylamine hydrochloride:

2Fe³⁺+2NH₂OH+2OH⁻→2Fe²⁺+N₂+4H₂O

Ferric (Fe³⁺) ion concentration was determined by obtaining the difference between total iron concentration and ferrous ion concentration.

### Example 2

### Preparation of Ferrous Iron Complexes

A 50 mM solution of ferrous di-pyruvate was prepared by reacting 13.9 grams of ferrous sulfate (heptahydrate) with 11 grams sodium pyruvate in one liter of deionized water.

A 150 mM solution of tri-ferrous di-citrate was prepared as follows. 21 grams citric acid monohydrate was titrated to pH 7.2 with KOH, to ionize all three carboxyl groups; and was then reacted with 41.7 grams of ferrous sulfate (heptahydrate) in one liter of deionized water. This solution was diluted with 2 volumes of water to yield a 50 mM solution.

### Example 3

### Ferrous Iron Content of Ferrous Di-Pyruvate and Tri-Ferrous Di-Citrate Complexes

The total iron content and the ferrous iron content of a 50 mM solution of each of the ferrous di-pyruvate and tri-ferrous di-citrate complexes were determined, as described in Example 1, immediately after their preparation as described in Example 2. As shown in Table 1, essentially all the iron was in the ferrous oxidation state for both complexes.

TABLE 1

| | Total iron | Ferrous iron | Ferric iron |
|---|---|---|---|
| Complex | (mM) | (mM) | (mM) |
| ferrous di-pyruvate | 50 | 49.5 | <1 |
| tri-ferrous di-citrate | 50 | 49.7 | <1 |

### Example 4

### Stability of Ferrous Di-Pyruvate and Tri-Ferrous Di-Citrate Complexes

The stabilities of the ferrous iron complexes were determined by measuring the amount of total iron remaining in ferrous form over a period of 180 days. Solutions were stored at room temperature in the dark. The results in Tables 2 and 3 show that after 180 days essentially all the iron remained in the ferrous oxidation state for both complexes.

TABLE 2
Stability of ferrous ion in the ferrous di-pyruvate complex

| Time after complex formation | | Total iron (mM) | Ferrous iron (mM) |
|---|---|---|---|
| 1 | Day | 100 | 99 |
| 60 | Days | 100 | 97 |
| 180 | Days | 100 | 98 |

TABLE 3
Stability of ferrous ion in the tri-ferrous di-citrate complex

| Time after complex formation | | Total iron (mM) | Ferrous iron (mM) |
|---|---|---|---|
| 1 | Day | 100 | 100 |
| 60 | Days | 100 | 99 |
| 180 | Days | 100 | 98 |

### Example 5

### Preparation of Ferric Tri-Pyruvate Complex

A 50 mM solution of the ferric tri-pyruvate complex was prepared by reacting 13.51 grams of ferric chloride (anhydrous) with 16.5 grams sodium pyruvate in one liter of deionized water.

### Example 6

### Reduction of Ferric Iron in the Ferric Tri-Pyruvate Complex

A 50 mM solution of the ferric tri-pyruvate complex was prepared as described in Example 5. The stability of the complex was measured by determining the total iron, ferrous iron and ferric iron over the course of 10 days. Table 4 shows that, upon formation of the ferric tri-pyruvate complex essentially all the iron was in the ferric oxidation state; however, over the course of a 7-day period, essentially all the ferric iron was reduced to the ferrous oxidation state.

TABLE 4
Stability of ferric ion in the ferric tri-pyruvate complex

| Time after complex | Total iron | Ferrous iron | Ferric iron |
|---|---|---|---|
| formation (days) | (mM) | (mM) | (mM) |
| 0 | 50 | <1 | >49 |
| 1 | 50 | 11 | 39 |
| 7 | 50 | 48 | 2 |
| 10 | 50 | 48 | 2 |

### Example 7

### Fenton Activity of Ferrous Complexes

The ability of the ferrous di-pyruvate and tri-ferrous di-citrate complexes to act as Fenton reagents was tested by combining 1 ml of a 50 mM solution of each complex with 1 ml of 40% H₂O₂ solution, in the presence of 0.1% (w/v) methylene blue and incubating for 1 hour at ambient temperature. Reactive oxygen species, generated by the Fenton Reaction, will degrade the blue dye, resulting in loss of blue color and in formation of ferric oxide and ferric hydroxide, which will precipitate out of solution.

Fenton reaction activity of the FDP and TFDC complexes was compared to the Fenton activity of mono-ferrous mono-citrate and mono-ferrous di-citrate complexes, as described in U.S. Pat. No. 8,945,631. The mono-ferrous mono-citrate complex (corresponding to Treatment Liquid B of U.S. Pat. No. 8,945,631) was prepared by combining equal parts sodium citrate and ferrous sulfate. The mono-ferrous di-citrate complex (corresponding to Treatment Liquid A of U.S. Pat. No. 8,945,631) was prepared by combining two equivalents of sodium citrate with one equivalent of ferrous sulfate.

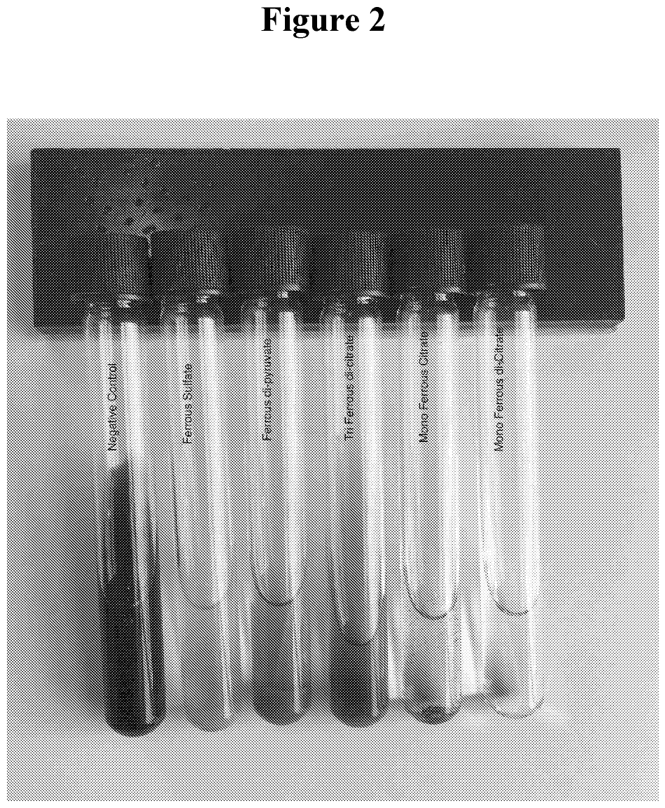

The results are shown in FIG. 2. Both the ferrous di-pyruvate complex (third tube from left) and the tri-ferrous di-citrate complex (fourth tube from left) had significant Fenton activity, as evidenced by loss of blue color and the formation of dense brown precipitates, containing ferric oxide and ferric hydroxide, in these tubes. In contrast, the mono-ferrous mono-citrate complex (fifth tube from left) and the mono-ferrous di-citrate complex (sixth tube from left) had little to no Fenton activity. The negative control (left-most tube) had a deep blue color with no precipitate.

### Example 8

### Fenton Activity of the Ferric Tri-Pyruvate Complex

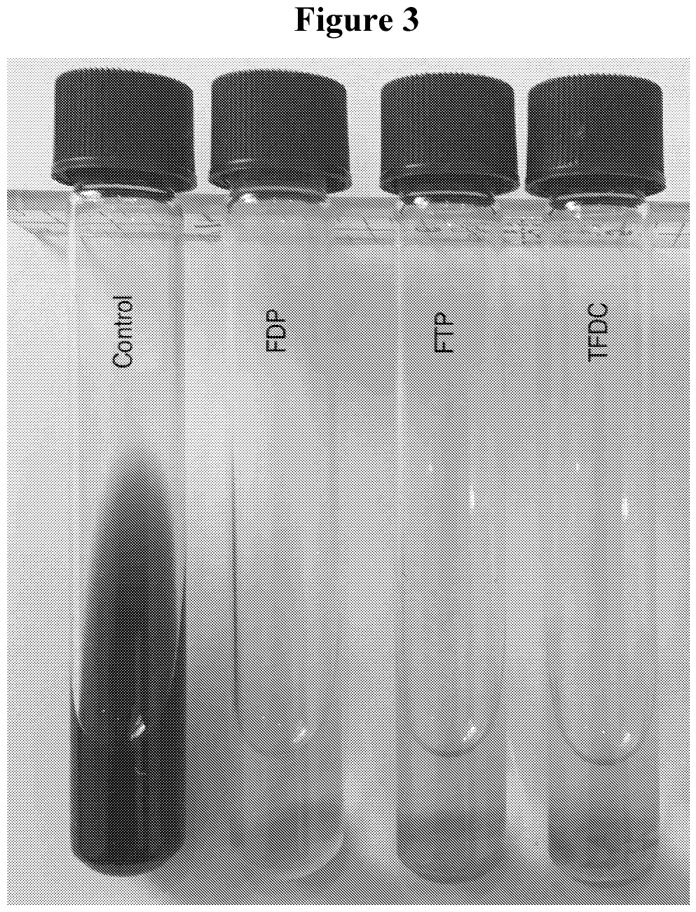

The ability of the ferric tri-pyruvate to act as a Fenton reagent was tested as described in Example 7. The results are shown in FIG. 3. A 14-day old reduced ferric tri-pyruvate complex (third tube from left) had significant Fenton activity, as evidenced by loss of blue color and the formation of dense brown precipitates, containing ferric oxide and ferric hydroxide. Ferrous di-pyruvate (second tube from left) and tri-ferrous di-citrate (fourth tube from left) also exhibited Fenton activity evidenced by loss of blue color and formation of a brown precipitate. The negative control (left-most tube) had a deep blue color with no precipitate.

### Example 9

### Reversal of Chlorosis Following Application of Ferrous Di-Pyruvate

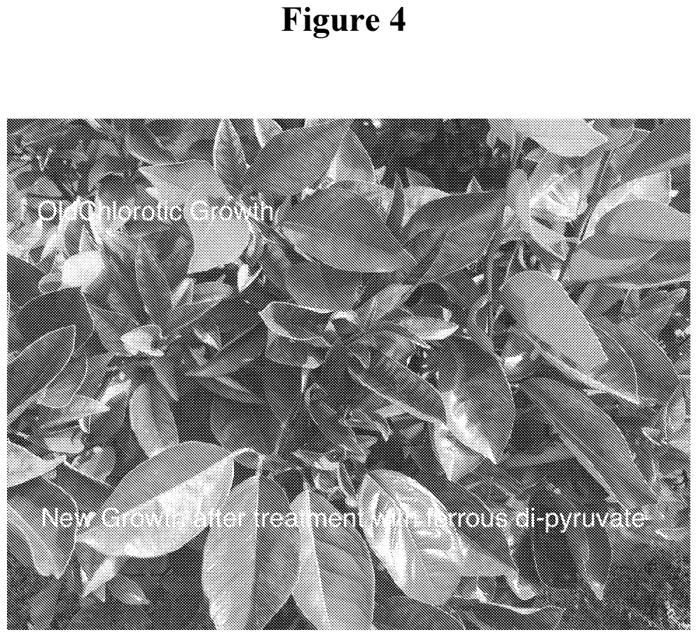

Chlorosis was induced in an orange tree by long-term neglect over a period of five years. The chlorotic tree was treated with a single foliar application of approximately 1 liter of a 50 μM solution of ferrous di-pyruvate, sprayed onto the undersides of the leaves. After three months, new growth of large, shiny, brightly-colored leaves (compared to the dull shriveled chlorotic leaves) was observed. See FIG. 4.

### Example 10

### Treatment of Banana Wilt with Ferrous Di-Pyruvate

The fungus Fusarium oxysporum is the causative agent of banana wilt (also known as Panama Disease). This disease has major economic consequences for the banana industry. F. oxysporum is resistant to fungicides; accordingly, control is limited to phytosanitary measures.

The ability of ferrous complexes to inhibit growth of F. oxysporum is tested by culturing the fungus on agar plates and placing small paper discs saturated with various concentrations of ferrous complex on the plate, in the presence and absence of H₂O₂. The results show that growth of F. oxysporum is inhibited by the Fenton reaction activities of the FDP and the TFDC complexes.

### Example 11

### Treatment of Phytopathogenic Infection (HLB) with Ferrous Di-Pyruvate

Ten HLB-infected rough lemon trees are treated every three days, over the course of three months, with H₂0 (negative control), a 50 μM solution of ferrous di-pyruvate or a 100 μM solution of ferrous di-pyruvate. As a positive control, 10 HLB-infected rough lemon trees are incubated at 42° C. for 10 days and subsequently incubated at room temperature for the duration of the experiment. At the conclusion of the treatments leaf and root samples are examined by PCR to detect the presence of C. liberibacter spp. In addition, the treated plants are also physically examined for indications of chlorosis, a symptom of HLB.

In the negative control plants, all leaf and root samples show evidence of C. liberibacter spp nucleic acid when analyzed by PCR and all plants are chlorotic. Treatment with 50 μM FDP, either foliar or by root drench, reduces the number of leaf and root samples containing C. liberibacter spp nucleic acid and reduces the number of plants showing signs of chlorosis; and treatment with 100 μM FDP, either foliar or by root drench, reduces the number of leaf and root samples containing C. liberibacter spp nucleic acid, and the number of chlorotic plants, even further. Positive control plants show no evidence of the presence of C. liberibacter spp nucleic acid when analyzed by PCR and do not appear chlorotic.

### Example 12

### Antibacterial Activity of FDP Against Xanthomonas

Xanthomonas is a genus of Protobacteria, many of whose species cause plant diseases. X. campestris is a gram-negative, rod-shaped bacterium that causes a variety of plant diseases, including black rot in crucifers. To test the bactericidal and bacteriostatic activities of the FDP complex, a saturated culture of X. campestris was diluted to an optical density (600 nm) of 0.6 in Nutrient Broth (NB, Difco) and either (1) cultured in the presence of the FDP complex (and other substances as indicated in Tables 5 and 6) for 36 hours at 28° C. or (2) cultured in the presence of ascorbate and copper for 24 hours at 28° C., then cultured for an additional 36 hours at 28° C. in the presence of the FDP complex and other substances (preincubation conditions as identified in Tables 5 and 6). After 36 hours of culture for condition (1) above, or 60 hours of culture for preincubation condition (2) above, the optical density at 600 nm was measured, and the number of colony-forming units (CFU) per ml of culture was determined by plating serial dilutions of the cultures on nutrient agar (NA agar, Difco).

The results shown in Table 5 indicate that FDP is able to block the growth of X. campestris; and the results shown in Table 6 show that FDP is able to kill X. campestris. In both cases, the effect was most pronounced after preincubation of cultures with ascorbate and copper, which allows hydrogen peroxide to accumulate in the growth medium. Reaction of FDP with the hydrogen peroxide generates reactive oxygen species, which are both bacteriostatic and bacteriocidal. In living plants, hydrogen peroxide is abundant (e.g., as a result of metabolic processes); thus; FDP is used to treat Xanthomonas infections in planta.

TABLE 5
Effect of FDP on growth of X. campestris

| Preincubation (24 hours) | Addition | A₆₀₀ |
|---|---|---|
| None | None | 0.504 |
| None | 5 mM ascorbate | 0.512 |
| None | 5 mM ascorbate + 5 μM Cu(II) | 0.464 |
| None | 5 mM ascorbate + 0.25 mM FDP | 0.447 |
| None | 5 mM ascorbate + 5 μM | 0.420 |
| | Cu(II) + 0.25 mM FDP | |
| 5 mM ascorbate + 5 μM | 5 mM ascorbate | 0.519 |
| Cu(II) | | |
| 5 mM ascorbate + 5 μM | 5 mM ascorbate + 0.25 mM FDP | 0.218 |
| Cu(II) | | |
| 5 mM ascorbate + 5 μM | 0.25 mM FDP | 0.320 |
| Cu(II) | | |

Ascorbate was added as sodium ascorbate in aqueous solution.
Cu(II) was added as CuSO₄ in aqueous solution.

TABLE 6
Effect of FDP (36 hour treatment) on X. campestris cell number

| Preincubation (24 hours) | Addition | CFU |
|---|---|---|
| None | None | 5 × 10¹¹ |
| None | 5 mM ascorbate + 5 μM | 2.28 × 10⁹ |
| | Cu(II) + 0.25 mM FDP | |
| 5 mM ascorbate + 5 μM | 5 mM ascorbate | 5.6 × 10¹¹ |
| Cu(II) | | |
| 5 mM ascorbate + 5 μM | 5 mM ascorbate + 0.25 mM | 1.05 × 10⁷ |
| Cu(II) | FDP | |

### Example 13

### Use of FDP as a Bactericidal and Sporicidal Agent

Because of its activity as a Fenton reagent, FDP produces reactive oxygen species (e.g. hydroxyl radicals, superoxide radicals) that are toxic to bacterial spores and spore-forming bacteria. Bactericidal and sporicidal activities of FDP are assessed by exposing cells or spores of Bacillus subtilis, suspended in water, to various concentrations of FDP (e.g., 1 mM, 2 mM, 3 mM, 4 mM, 5 mM, 6 mM, 7 mM, 8 mM, 9 mM, 10 mM, 12.5 mM, 15 mM, 20 mM, 25 mM, 50 mM, 75 mM 100 mM or more) in the presence of 10 mM sodium ascorbate and a sub-inhibitory concentrations of hydrogen peroxide (e.g., 1 mM or less, 2 mM or less, 3 mM or less, 4 mM or less, 5 mM or less, 6 mM or less, 7 mM or less, 8 mM or less, 9 mM or less, 10 mM or less, 12.5 mM or less, 15 mM or less, 20 mM or less, 25 mM or less, 30 mM or less, 40 mM or less, 50 mM or less, 60 mM or less, 70 mM or less, 80 mM or less, 90 mM or less, 100 mM or less, 125 mM or less, 150 mM or less, 175 mM or less, or 200 mM or less). After exposure to FDP for various periods of time, the number of viable colony-forming units is determined by plating aliquots of serial dilutions of the solutions. The results indicate that increasing concentrations of FDP, as well as exposure of cells or spores to FDP for increasing amounts of time, result in higher levels of cell killing.

In additional experiments, surfaces that have been intentionally contaminated with spores of B. subtilis are wiped or sprayed with solutions of FDP (e.g., 1 mM, 2 mM, 3 mM, 4 mM, 5 mM, 6 mM, 7 mM, 8 mM, 9 mM, 10 mM, 12.5 mM, 15 mM, 20 mM, 25 mM, 50 mM, 75 mM 100 mM or more); optionally including ascorbate (e.g. 10 mM) and/or hydrogen peroxide at a concentration of, e.g., 1 mM or less, 2 mM or less, 3 mM or less, 4 mM or less, 5 mM or less, 6 mM or less, 7 mM or less, 8 mM or less, 9 mM or less, 10 mM or less, 12.5 mM or less, 15 mM or less, 20 mM or less, 25 mM or less, 30 mM or less, 40 mM or less, 50 mM or less, 60 mM or less, 70 mM or less, 80 mM or less, 90 mM or less, 100 mM or less, 125 mM or less, 150 mM or less, 175 mM or less, or 200 mM or less. The surfaces are then swabbed, the swabs are suspended in water or medium, and CFU are determined by plating aliquots of serial dilutions of the liquid in which the swabs were suspended. Swabbing or spraying contaminated surfaces with FDP (optionally mixed with ascorbate and/or hydrogen peroxide), sterilizes the surfaces, removing both spores and bacteria.

### Example 14

### Effect of FDP on Pectobacteriumcarotovorum Subsp. brasiliense for the Management of Soft Rot and Blackleg in Potatoes

Pectobacterium spp. infect a broad host range of plants and cause soft rot, wilting and blackleg in potatoes (Solanum tuberosum L.). Onkendi & Moleleki (2014) Eur. J. Plant Pathol. 139:557-566. Pectobacterium carotovorum subsp. brasiliense (Pcb), a member of the Pectobacteriaceae family, is highly virulent and is the most widespread of the Pectobacteriaceae. Ngadze et al. (2012) Eur. J. Plant Pathol. 134:533-549.

Symptoms of infection by Pcb include tuber soft rot and blackleg. Czajkowski et al. (2011) Plant Pathol. 60:999-1013; van der Merwe et al. (2010) J. Plant Pathol. 126:175-185. Soft rot occurs when bacteria colonize progeny tubers and release pectinases and other cell wall degrading enzymes, which break down the cell walls, causing tissue maceration to occur. Ngadze et al., supra. Blackleg occurs when the stems of potatoes are colonized and a slimy, black rot spreads up the stem from the mother tuber. Ngadze et al., supra. These symptoms result in infected potatoes being unfit for consumption.

There are currently no effective post-infection treatments that can consistently manage colonization and symptom development in potato plants once infection by Pcb has occurred. Furthermore, attempts to breed Pectobacterium-resistant potato cultivars that retain other favorable characteristics, such as tuber size, have been unsuccessful.

Hydrogen peroxide occurs naturally in plants, and can be converted into hydroxyl radicals in the presence of transition metals such as iron (II) and copper (II). Vellosillo et al. (2010) Plant Physiol. 154:444-448. This example describes the use of the FDP complex to mobilize the conversion of endogenous hydrogen peroxide in plants to reactive oxygen species that are able to kill pectobacteria.

Isolation of Bacteria

Samples 5 mm in diameter and 5 mm deep are cut from symptomatic potato tubers and stems using sterile equipment. Samples are macerated in BioReba bags (BioReba®, Reinach, Switzerland) with 9 ml of sterile, distilled water. The mixture is serially diluted and 100 μl of each concentration is plated in replicate onto Crystal Violet Pectate (CVP) agar and spread to obtain single colonies. CVP is a semi-selective medium that allows for the isolation of Pectobacterium spp. and Dickeya spp. from the pits formed due to pectin digestion. The plates are incubated in the dark at 20° C., 25° C. and 28° C., and are observed for 24-48 hours. Colonies are transferred from the pits using a flamed inoculation loop onto Nutrient Agar (NA, Biolab) to obtain pure colonies.

Molecular Identification of Pcb

Genomic DNA is extracted from pure colonies using the Quick-DNA Fungal/Bacterial Miniprep kit (Zymo Research Corporation) according to the manufacturer's instructions. Polymerase chain reaction (PCR) amplification of the 16S-23S ITS region is performed according to the protocol for OneTaq® DNA Polymerase by New England Biolabs, using a primer pair that is subspecies-specific for Pcb. See Duarte et al. (2004) J. Applied Microbiol. 96:535-545; and Onkendi & Moleleki (2014) supra. The PCR product is stained and separated on an agarose gel in TAE buffer along with a standard molecular ladder. The size of the amplicon is 322 base pairs.

Phytotoxicity Trial

Tubers are planted in sandy loam potting soil in 25 cm diameter pots and grown at 25° C. in a greenhouse. Plants are watered and fertilized as needed. Different concentrations of the FDP complex are tested to determine the highest concentration that can be tolerated by potato plants, (e.g., cv. Mondial). In one experiment, the concentrations are 50 μM, 100 μM, 150 μM, 200 μM, 250 μM and 300 μM. The effect of route of application, i.e., root drench or foliar spray, is also tested at each concentration; with five replicates for each concentration/application combination. Treatments are applied weekly, and phytotoxicity symptoms are recorded weekly over a 100-day period. Data are statistically analyzed using the ARM statistical package (Revision 2019.8).

These experiments indicate maximum concentrations of FDP that can be used with causing phytotoxicity.

In Vitro Trial

The effectiveness of the FDP complex as a bactericide is tested in vitro in suspensions of Pcb. To allow for hydrogen peroxide (H₂O₂) accumulation, 5 μM copper sulfate and 4 mM sodium ascorbate are added to ¼ strength Ringer's solution (Oxoid) and agitated for 24-48 hours; after which Pcb is added to a concentration of 5×10¹¹ colony forming units (CFU)/ml, along with fresh 5 mM sodium ascorbate and 0 μM, 50 μM, 150 μM or 250 μM of the FDP complex (with five replicates of each sample). After 36 hours, the concentration of Pcb at each concentration of FDP is determined (e.g., by optical density and/or by plating aliquots of serial dilutions of the suspensions) and compared to that of the control sample. Controls include samples which have not received FDP, and samples containing each of the four concentrations of FDP that have not been pre-incubated with copper sulfate and sodium ascorbate. Data is statistically analyzed using the ARM statistical package (Revision 2019.8).

These experiments reveal minimum concentrations of FDP the exhibit bactericidal activity, and provide information on dose-response.

In Planta Trial

The concentrations of the FDP complex used for in planta trials is determined by the results obtained in the phytotoxicity and in vitro trials, described above. Disease-free mini-tubers (e.g., cv. Mondial) are infiltrated with an inoculum of 10⁸ CFU/ml Pcb prepared in Ringer's solution. Control tubers are infiltrated with distilled water. Infiltrated tubers are planted in sandy loam potting soil in 25 cm diameter pots and grown at 25° C. in a greenhouse. FDP complex is diluted in water (with a pH of 6.0-6.5) and applied to the plants weekly as a foliar spray or as a root drench. In one experiment FDP concentrations of 150 μM, 200 μM and 250 μM are tested, with five replicates of each concentration. Control plants receive applications of sterile water. Plants are watered and fertilized as necessary. A randomized complete block experimental design is used.

Symptoms of Pcb colonization such as aerial stem rot, blackleg and wilting are recorded separately on a rating scale of 0 to 5 every week, beginning at the appearance of first symptoms and continuing until harvest. A rating of 0 represents no symptoms, whereas a rating of 5 represents severe symptoms such as stem collapse resulting from decay or wilting of all leaves. These ratings are compared to those of positive controls (e.g., no infiltration or infiltration with water) and negative controls (e.g., no FDP applied to infiltrated plants). The trial is repeated and all data is statistically analyzed using the ARM statistical package (Revision 2019.8).

Results indicate that treatment of plants with FDP and/or TFDC reduce symptom of Pcb infection.

1-6. (canceled)

7. A method for treatment of iron deficiency in a plant, the method comprising:
(a) contacting the plant with a complex comprising:
(i) a ferrous (Fe²⁺) ion, and
(ii) two molecules of pyruvate ion; or
(b) contacting the plant with a complex comprising:
(i) three ferrous (Fe²⁺) ions, and
(ii) two molecules of citrate ion.

8. The method of claim 7, wherein the iron deficiency results in chlorosis.

9. The method of claim 7, wherein contacting is by root drench.

10. The method of claim 7, wherein contacting is by foliar application.

11. A method for treating an infection in a plant, the method comprising:
(a) contacting the plant with a complex comprising:
(i) a ferrous (Fe²⁺) ion, and
(ii) two molecules of pyruvate ion; or
(b) contacting the plant with a complex comprising:
(i) three ferrous (Fe²⁺) ions, and
(ii) two molecules of citrate ion.

12. The method of claim 11, wherein the infection is a bacterial infection.

13. The method of claim 12, wherein the bacterium is Candidatus Liberibacter spp.

14. The method of claim 13, wherein the infection causes citrus greening disease (HLB).

15. The method of claim 12, wherein the bacterium is Xanthomonas campestris.

16. The method of claim 15, wherein the infection causes banana Xanthomonas wilt.

17. The method of claim 11, wherein the infection is a fungal infection.

18. The method of claim 17, wherein the fungus is Fusarium oxysporum.

19. The method of claim 18, wherein the infection causes Banana Wilt.

20-26. (canceled)

27. A method for producing an iron-fortified food, the method comprising contacting a plant with
(a) a complex comprising:
(i) a ferrous (Fe²⁺) ion, and
(ii) two molecules of pyruvate ion;
(b) a complex comprising:
(i) three ferrous (Fe²⁺) ions, and
(ii) two molecules of citrate ion; or
(c) a complex comprising:
(i) a ferric (Fe³⁺) ion, and
(ii) three molecules of pyruvate ion.

28. The method of claim 27, wherein contacting is by root drench.

29. The method of claim 27, wherein contacting is by foliar application.

30. The method of claim 27, wherein the plant is a vegetable.

31. The method of claim 27, wherein the plant is a grain.

32-72. (canceled)
